(19) United States
(12) Patent Application Publication
(10) Pub. No.: US 2005/0048179 A1
(43) Pub. Date: Mar. 3, 2005

(54) Method for regulating extrudate flow in a cooling die

(75) Inventors: David Alexander, Wodonga (AU); Kevin Rees, Wodonga (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 10/928,015

(22) Filed: Aug. 27, 2004

(30) Foreign Application Priority Data
Aug. 29, 2003 (AU) 2003904711
Oct. 17, 2003 (AU) 2003905701

(51) Int. Cl. B29D 9/00

(52) U.S. Cl. 426/516

(57) ABSTRACT

A method of modulating the flow of fluid extrudate as it passes through one or more product cooling channels in an extrudate cooling die, said cooling die utilising the flow of a coolant through one or more coolant flow channels, from a coolant inlet point to a coolant outlet point, at least one of said coolant flow channels being located in thermal proximity to at least an associated one of said product cooling channels, to effect cooling of the extrudate from an extrudate inlet temperature to an extrudate outlet temperature.

### CROSS-REFERENCE TO RELATED APPLICATIONS

This application claims priority to Australian Application No. 2003904711 filed Aug. 29, 2003 and Application No. 2003905701 filed Oct. 17, 2003.

### TECHNICAL FIELD

The invention relates to the field of extrusion of food products. In particular, it relates to a method of regulating the flow of extrudate flowing in the channels of a multi-channel cooling die.

### BACKGROUND OF THE INVENTION

In the field of commercial food manufacture, in particular in the field of commercial pet food manufacture, it is often desired to produce a low-cost meat analogue for inclusion in a food matrix, in order to ensure that the food has an authentic “meaty” appearance, without incurring the high raw material cost associated with muscle meat. A particularly effective process for producing such meat analogues is disclosed in Patent Document No. WO 00/69276, by Effem Foods Pty Ltd. The process there described involves the use of a cooling die to effect gradual solidification of a high-moisture, protein-based extrudate, thereby creating a “fibrous” internal texture.

Of course, a limitation to the commercial usage of cooling dies in high moisture extrusion applications has been that such cooling dies tend not to be able to cope with the higher extrudate flow rates that are required when making a commercially viable food product, for example in excess of 200 kg of product per hour per extrusion unit.

In order to overcome this problem, it has therefore become necessary to improve the overall efficiency of extrudate cooling dies. One such improved design is disclosed in Patent Document No. WO 01/49474, by Effem Foods Pty Ltd. This document discloses a multi-channel cooling die which is capable of producing a texturised, high moisture extrudate at overall mass flow rates around one ton per hour per extrusion unit.

However, one potential problem arises with multi-channel cooling dies where a single product stream exiting the extruder is split into a multitude of individual flow streams upon entry into the cooling die. The product quality achievable in each of the extrudate cooling channels depends to a large extent on ensuring a relatively even distribution of flow rates between and within each of the individual channels. In operation of a multi-channel die manufactured in accordance with WO 01/49474, it has been noted that variations in the extrudate flow rate passing through each of the individual channels of the cooling die may tend to vary, particularly during high flow rate operations. This is because if the flow of extrudate in any one channel is reduced, this extrudate will receive additional cooling, which causes the viscosity to increase and the flowrate to further decrease. The additional back-pressure generated in this channel tends to cause an increased flowrate in other channels. This means that the extrudate flowing in those other channels will receive a lack of cooling and its viscosity will decrease, which in turn allows further increase in the flowrate. This tends to produce an inherently unstable system.

This can adversely affect product quality: extrudate passing too slowly through the die can fail to develop the desired internal texture, as the too great level of cooling results in an extrudate which is too dense, less striated and consequently less ‘meat like’; extrudate passing too rapidly through the die can fail to cool sufficiently and may consequently ‘puff’ upon exit from the cooling die, again producing a less ‘meat like’ texture due to the over expanded internal texture, which results in a “ragged” appearance with higher fines levels; inconsistent flow can lead to an unacceptable variation in the cut length of the extrudate pieces upon exiting the cooling die. Slow-moving extrudate results in short chunks, with increased fines; fast-moving channels results in excessively large chunks.

A well known method of regulating the flow of fluid materials is to dynamically measure their volume- or mass-flowrate, compare with a predetermined set value, and initiate a direct physical influence on the fluid stream in order to correct any discrepancy, eg via a control valve.

However, in food extruder cooling die applications, this approach may be very difficult to implement. Measurement of the flow of a material that is undergoing a gradual solidification, at elevated temperature and pressure, cannot successfully be performed in a manner that would allow economical application to food extrusion. This is especially so in the context of a multi-channel cooling die, where each channel may potentially require individual monitoring and control.

### BRIEF SUMMARY OF THE INVENTION

It is an object of the present invention to provide a practical method of implementing active flow control of the extrudate flowing through a multi-channel cooling die, in order to address some or all of the problems noted above.

According to one aspect of the invention, there is provided a method of modulating the flow of fluid extrudate as it passes through one or more product cooling channels in an extrudate cooling die, said cooling die utilizing the flow of a coolant through one or more coolant flow channels, from a coolant inlet point to a coolant outlet point, at least one of said coolant flow channels being located in thermal proximity to at least an associated one of said product cooling channels, to effect cooling of the extrudate from an extrudate inlet temperature to an extrudate outlet temperature, including the steps of:
measuring the temperature of the coolant at said coolant outlet point;
comparing this temperature with a predetermined expected value, being a function of at least one of: extrudate flow rate, extrudate inlet temperature, coolant inlet point temperature and coolant flow rate;
causing at least one variable to be adjusted upward or downward thereby to modulate said extrudate flowrate in order to achieve said predetermined expected value, said variable being selected from one of said instantaneous coolant flowrate and said coolant inlet point temperature.

Preferably, the coolant is provided at a substantially constant inlet point temperature, and said coolant flow rate is adjusted upward or downward thereby to modulate said extrudate flow rate in order to achieve said predetermined expected value.

Alternatively, the coolant may be supplied at a substantially constant flow rate, and said coolant inlet point temperature is adjusted upward or downward thereby to modulate said extrudate flow rate in order to achieve said predetermined expected value.

An advantage of this method is it enables the exertion of a degree of control over the flow of extrudate, particularly in each individual product cooling channel, or alternatively in a group of such channels, without having to directly measure the actual flow-rate in each such channel, viscosity or other rheological property of the extrudate, which may be very difficult or impractical. This is especially advantageous where the action of the cooling die is to cause the extrudate to at least partially solidify at the exit point of the die, making conventional flow measurement very difficult.

This is made possible via the inventive realization that the temperature of the coolant flowing adjacent an extrudate flow channel (ie product cooling channel) will tend to relate to the flowrate of the extrudate in any given such channel.

The invention therefore allows the extruder/cooling die control system to detect where one or more extrudate cooling channels are experiencing low extrudate flow, due to a blockage or the like, which is characterised by low coolant outlet temperature for the respectively associated coolant flow channel(s), or high extrudate flow, due to surging, which is characterised by high coolant outlet temperature. The inventive method further provides a remedy for these situations, wherein by increasing coolant flow, or decreasing coolant temperature, in one or more of the coolant flow channels assigned to provide cooling for any given product cooling channel, the extrudate solidification may be promoted, thereby reducing the excessive flow of extrudate in its channel(s), or wherein by decreasing coolant flow, or increasing coolant temperature, the extrudate solidification may be restrained, thereby increasing the flow of extrudate.

For applications where control of flow in each individual product (extrudate) cooling channel is logistically difficult or prohibitively expensive, an advantageous embodiment of the invention is provided, wherein in the case of a multi-channel cooling die having a large number of extrudate channels, individual coolant streams are provided to a predetermined number of individual cooling die zones, each zone containing a predetermined number of individual extrudate channels, and wherein the inventive method is applied to each zone via its individual coolant flow stream. Such a regime allows extrudate flows to be relatively equalised in between broad regions of the die. Of course, flows may not be equalised among individual extrudate cooling channels within each region, but this embodiment allows a good level of overall control of extrudate flow without the possibly expensive and impractical requirement to control a large number of individual product cooling channels.

For example, where a multi-channel cooling die comprised 24 individual extrudate cooling channels, it may be prudent to provide a coolant flow channel system or grid to service six groups of four adjacent channels, and to independently apply the inventive method to each of the said six groups. Alternatively, any suitable combination may be used, such as four groups of six channels, eight groups of three channels, etc.

According to another aspect of the invention, there is provided a multi-channel cooling die which incorporates an extrudate flow modulation regime according to any one of those described above.

According to another aspect of the invention, there is provided an extrudate flow modulation system which implements the methodology of the present invention.

According to another aspect of the invention, there is provided an extruded food product, produced with the assistance of a cooling die which incorporates an extrudate flow modulation regime according to any one of those described above.

Now will be described, by way of a specific, non-limiting example, a preferred embodiment of a method of modulating extrudate flow in a multi-channel cooling die according to the invention. From the below description, further preferred and optional features of the invention will become apparent.

### BRIEF DESCRIPTION OF THE DRAWINGS

Now will be described, by way of a specific non-limiting example, a preferred embodiment of the invention, with reference to the figures.

FIG. 1 is a schematic plan view of a multi-channel cooling die according to the prior art, to which the present invention may be applied.

FIG. 2 is a cross-section of the cooling die of FIG. 1 at line A-A, showing detail of the cooling fluid path at the end (coolant distribution) plate of the cooling die plate stack;

FIG. 3 is a cross-section of the cooling die of FIG. 1 at line B-B, showing the arrangement of extrudate flow channels and the coolant flow bores;

FIG. 4 is a schematic of the control regime according to the invention.

### DETAILED DESCRIPTION OF THE INVENTION

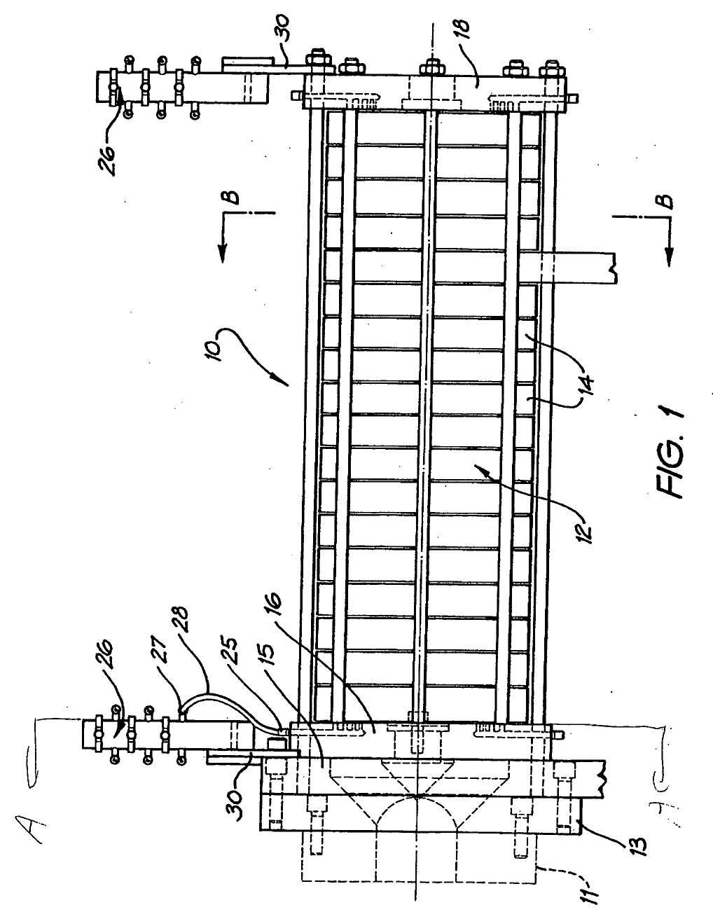

Turning first to FIG. 1, there is shown a stacked plate type multi-channel cooling die, for attachment to a food extruder according to that disclosed in Patent Document No. WO 01/49474, by Effem Foods Pty Ltd.

The die assembly 10 essentially comprises a multi-piece die body 12 consisting of a plurality (here: 18) of disc-shaped thick metal plates 14 of identical layout, a coolant (i.e. cooling fluid) inlet header (or distribution) plate 16 at the axial inlet end of the die body 12, a coolant outlet header (or distribution) plate 18 at the axial outlet end and connection and transition structures for securing die 10 to a receptacle flange at the extruder outlet (notionally represented at dotted line 11) and clamping of the individual die body plates 14 together.

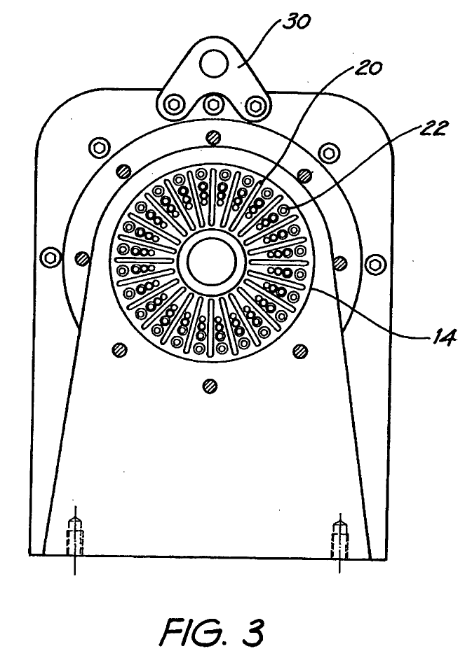

A total of twenty-four extrudate flow channels extend axially and parallel to one another between the inlet end of die body 12 and the outlet end thereof, partial sections of the extrudate flow channels being defined by bores or “part channels” extending through each of the plate members 14 that make up die body 12. FIG. 3 illustrates in cross-section one of the cooling die plates 14 which, when stacked and clamped together, form cooling die body 12. The bores that make up the extrudate flow channels are identified at 20. The cross-section of the extrudate flow channels 20 is identical and about rectangular with rounded edges (or in the form of long holes/oblong). The major dimension or height of the channel 20 extends in a substantially radial direction from the central axis of the die body 12, and is at least 2.5 times the width thereof. The twenty-four extrudate flow channels 20 are equidistantly spaced in circumferential direction of the plate members 14.

As can be further gleaned from FIG. 3, a plurality of bores 22 are machined into and extend through each die body plate 14 in a regular pattern and located between neighboring extrudate flow channels 20, a total of four radially spaced apart bores being provided per row. When the individual die plates 14 are stacked, these bores 22 form a plurality of coolant flow channels which extend parallel to one another between the product inlet and outlet ends of die body 12.

As noted above, at each end of cooling die body 12 are located cooling fluid (i.e. coolant) header plates 16, 18 which provide the terminal ends for the coolant flow channels 22 at the product inlet and outlet sides of the die assembly 10. These are in essence mirror-identical to one another, the only difference being their location with respect to extrudate flow through the cooling die, i.e. inlet and outlet end plates. Because these end plates 16, 18 also perform a function of distributing coolant from a single source to the individual coolant flow channels 22 of the die plate assembly 12, or receiving such coolant, they are here also referred to as distribution (end) plates 16, 18.

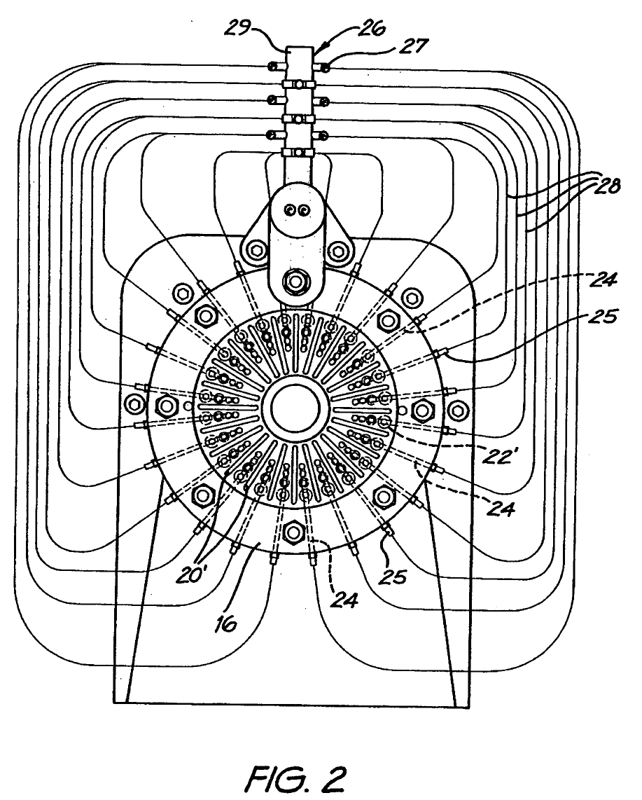

As can be seen from FIG. 2, which illustrates schematically and in cross-section one such coolant header plate 16, a total of twenty-four radially extending coolant supply/discharge bores 24 extend from respective coupling armatures 25 located at regular intervals along the peripheral surface of the disc-shaped distribution plate 16 towards the centre thereof and terminate with distance thereof. Each supply/discharge bore 24 is in fluid communication with a total of four coolant flow bores 22′ machined from one side only axially into the distribution,plate 3. The sack bores 22′ are shaped to correspond in cross-section, arrangement pattern and location with the coolant flow channels 22 provided in the cooling die plates 14 (compare FIG. 3), with whom they align when the plates 14, 16, 18 are stacked.

As can be further seen in FIG. 2, the distribution plate 16 (as well as 18) also has twenty-four long holes 20′ which are arranged in a pattern and have a size corresponding to that of the extrudate flow channels 20 of the cooling die plates 14 (and cooling die body 12) with whom these align when the die is assembled.

In the prior art, a coolant distribution manifold structure 26 incorporates a total of twelve coupling armatures 27 fastened to a common supply/discharge tube 29. Tube 29 is secure/fixed vie bracket 30 to the upper side of distribution plate 16 (and 18) or any other suitable component of the cooling die assembly. A total of twenty-four coolant lines 28 connect the coupling armatures 25 and 27 thereby to allow manifold feeding of coolant through a single inlet to the twenty-four individual coolant supply ducts 24 at the inlet end plate 16. The same configuration is present at the outlet end distribution plate 18.

In use of the production facility, molten lava (i.e. extrudate) from the extruder flows through extruder outlet into attachment flange piece 13 and through extrudate distributor (i.e. transition) plate 15 before passing through coolant distribution (end) plate 16 and entering the first of the cooling plate members 14. The flow of extrudate is evenly distributed over all product channels 1 due to all product paths being of similar lengths. Once the extrudate has entered the first of the stacked cooling plates 14 it passes through the extrudate flow channels 20 formed by individual cooling plates attached together before exiting the cooling die via the outlet cooling fluid distribution plate 18. The total number of cooling plates 14 may be varied according to the heat transfer area required for the specific product.

It will be recognized that the thermal proximity of the extrudate flow channels to the coolant flow channels, ie their physical proximity and their separation by a relatively small area of thermally conductive material such as steel, contributes to the transfer of heat from the extrudate to the coolant. This causes the temperature of the extrudate to drop, with a concomitant rise in coolant temperature. Effectively, the amount of energy lost by the extrudate along the length of the extrudate channel will be approximately equal to the amount of energy gained by the thermally adjacent coolant streams.

It has been further recognized by the inventor that for extrudate flowing in the extrudate channel at a constant rate of F_{E}, entering at a temperature of T_{EI} and exiting at a temperature of T_{EO}, there will be a concomitant rise in coolant temperature, in thermally adjacent coolant channels, from T_{CI} to T_{CO}, for a given constant coolant flow of F_{C}. It has also been recognized that the amount of energy transferable from the extrudate in the die itself will depend in part upon the amount of time any given element of the extrudate remains in thermal proximity to the coolant, which in turn depends on F_{E}.

If the flow rate of extrudate through the channel F_{E} is reduced, then the extrudate will spend longer in thermal proximity with the coolant, reducing T_{EO}. This causes the rate of energy transfer to the coolant to decrease because of the reduced temperature driving force between T_{E} and the coolant temperature T_{C}. Therefore, T_{CO} will decrease. If the flow rate of extrudate through the channel F_{E} is increased, then the extrudate will spend less time in thermal proximity with the coolant, and T_{EO} will be increased. This causes the rate of energy transfer to the coolant to increase because of the increased temperature driving force between T_{E} and T_{C}. This causes T_{CO} to increase. This principle allows the change in flow of the extrudate in individual channels to be detected. In addition, it has also been recognized that an increase in the flow of cooling water will increase the rate of energy transfer from the extrudate, but the cooling water temperature increase will be lower due to the reduced time in thermal proximity with the extrudate. This will tend to maintain a lower coolant temperature along the length of the coolant flow stream. Therefore, increasing coolant flowrate will tend to cause more rapid solidification of the extrudate as it flows through the die, which in turn will tend to reduce F_{E}.

Therefore, it now becomes possible to modulate F_{E} by raising or lowering F_{C} in response to changes in T_{CO}.

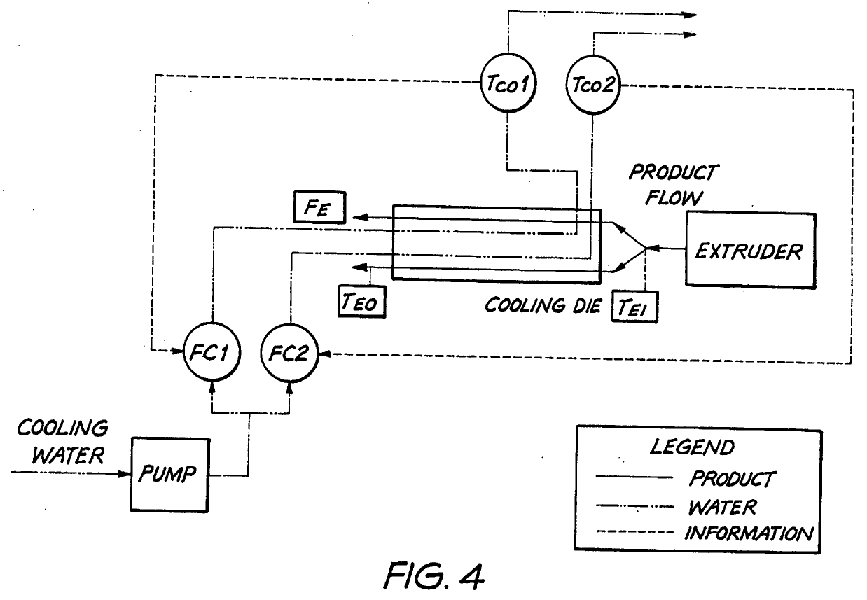

This can be practically implemented in a working multi-channel cooling die according to the schematic flow diagram shown in FIG. 4. In this example, coolant is shown flowing counter-current to extrudate flow.

Temperature sensors positioned at the coolant outlet detect T_{CO} for each coolant stream. If the value of T_{CO} exceeds a set value, indicating an increase in extrudate flow F_{E}, a control device, such as a programmable logic controller (PLC) actuates a flow control mechanism FC, such as a solenoid valve, positioned in the coolant stream prior to entering the cooling die, to increase coolant flow F_{C}. This will encourage F_{E} to decrease. If T_{CO} is below a set value, indicating a decrease in extrudate flow F_{E}, the control device, actuates the flow control device to decrease coolant flow F_{C}, encouraging F_{E} to increase.

Routine experimental data is of course required to determine the target level for T_{C}. It will be appreciated that this value will be different for every particular set of processing conditions, as it will necessarily vary with variations in F_{E}, F_{C}, T_{CI} and potentially with the thermodynamic properties and rheology of different extrudate materials.

For example, it has been found that, for the cooling of extrudate material of the type disclosed in WO 01/49474 via equipment disclosed therein, where the processing conditions are thus:
F_{E}=42 kg/hr
F_{C}=70 kg/hr
T_{CI}=20° C.
The target value for T_{CO} will be approximately 50° C.

In an alternate embodiment, particularly where the application of individual control loops to every extrudate channel is difficult or uneconomic, it has been possible to obtain a useful level of flow control where the overall cooling die is divided into control zones consisting of a group of extrudate channels, and the method of flow control is applied to the group, and not to each channel individually.

For example, where 24 individual extrudate flow channels are provided in a circular arrangement around an axis of the multi-channel cooling die, it may be convenient to ‘divide’ the die into six segments of four extrudate channels. Coolant flow, passing in parallel through six single flow control devices, may be directed to the thermally adjacent coolant channels corresponding to the four extrudate channels in each of the six segments of the die. Upon passing through the die, the coolant supplied to an individual segment may be recombined and TCO may be measured. The resultant temperature measurement may then be used to actuate the flow control device corresponding to that particular segment of the die. Or course, such a regime will not provide the sensitivity of a regime that specifies an individual feedback control loop for each extrudate channel. However, practical experience suggests that such a system is an economical alternative, which nevertheless substantially contributes to effective product quality control.

It will be appreciated by those skilled in the art that a control regime according to the invention, and merely exemplified above, may be applied to a working multi-channel cooling die in a variety of different ways while nevertheless remaining within the scope of the present invention. For example, the choice of temperature sensors, flow control devices and control hardware is myriad, as is their precise positioning and arrangement. So too, the inventive method may be applied to a wide range of multi-channel cooling or heating devices whose operating principles make them suitable, for example the longitudinally arranged device disclosed in patent document no. WO 03/004251, and to a virtually limitless variety of extrudates whose properties make them suitable.

In addition, where the above example involves the modulation of flow-rate of coolant supplied at a substantially constant temperature, the invention may equally be embodied by a system that involves the supply of coolant at constant flow-rate and in which the coolant temperature is varied to produce the desired effect on extrudate rheology.

1. A method of modulating the flow of fluid extrudate as it passes through one or more product cooling channels in an extrudate cooling die, said cooling die utilising the flow of a coolant through one or more coolant flow channels, from a coolant inlet point to a coolant outlet point, at least one of said coolant flow channels being located in thermal proximity to at least an associated one of said product cooling channels, to effect cooling of the extrudate from an extrudate inlet temperature to an extrudate outlet temperature, comprising the steps of:
measuring the temperature of the coolant at said coolant outlet point;
comparing this temperature with a predetermined expected value, the value being a function of at least one of: extrudate flow rate, extrudate inlet temperature, coolant inlet point temperature and coolant flow rate;
causing at least one variable to be adjusted upward or downward thereby to modulate said extrudate flowrate in order to achieve said predetermined expected value, said variable being selected from one of said instantaneous coolant flowrate and said coolant inlet point temperature.

2. The method of claim 1, wherein said coolant is provided at a substantially constant inlet point temperature, and said coolant flow rate is adjusted upward or downward thereby to modulate said extrudate flow rate in order to achieve said predetermined expected value.

3. The method of claim 1, wherein said coolant is supplied at a substantially constant flow rate, and said coolant inlet point temperature is adjusted upward or downward thereby to modulate said extrudate flow rate in order to achieve said predetermined expected value.

4. The method of claim 1, wherein said extrudate die is a multi-channel cooling die, and wherein individual coolant streams are provided to a predetermined number of individual cooling die zones, each zone containing a predetermined number of individual extrudate channels, and wherein the method is applied to each zone via its individual coolant flow stream.

5. The method of claim 4, wherein said multi-channel cooling die has 24 individual extrudate cooling channels, the number of zones is six, each zone comprising four individual extrudate channels.

6. An extrudate cooling die which is adapted to implement the method of claim 1.

7. An extrudate flow modulation system which is adapted to implement the method of claim 1.

8. An extruded food product produced via the facility of the extrudate cooling die of claim 6.

9. An extruded food product produced via the facility of the extrudate extrudate flow modulation system of claim 7.

10. (Canceled)

11. (Canceled)
